(19) United States
(12) Patent Application Publication
(10) Pub. No.: US 2022/0412146 A1
(43) Pub. Date: Dec. 29, 2022

(54) METHOD AND CONTROL DEVICE FOR OPERATING A BOARDING SYSTEM FOR A VEHICLE AND BOARDING SYSTEM FOR A VEHICLE

(71) Applicant: KNORR-BREMSE GESELLSCHAFT MIT BESCHRÄNKTER HAFTUNG, Mödling (AT)

(72) Inventors: Johann BRAMAUER, Ybbsitz (AT); Reinhard EKKER, Scheibbs (AT)

(21) Appl. No.: 17/642,797

(22) PCT Filed: Sep. 10, 2020
(86) PCT No.: PCT/EP2020/075281

§ 371 Date: Mar. 14, 2022

(30) Foreign Application Priority Data
Sep. 13, 2019 (EP) 19197161.3

(51) Int. Cl. E05F 15/659; B61L 15/00; B61L 27/50

(52) U.S. Cl. CPC E05F 15/659; B61L 15/0072; B61L 27/50; E05Y 2400/44; E05Y 2400/40; E05Y 2900/51; E05Y 2900/531; E05Y 2400/30; E05Y 2201/434; E05Y 2400/36

(57) ABSTRACT

A method for operating a boarding system for a vehicle includes reading in an inclination signal. The inclination signal represents an inclination of the boarding system relative to a reference. The method also includes reading in at least one movement process of at least one boarding element of the boarding system representing process signals and includes determining an operating signal for operating the boarding system using the inclination signal and the at least one process signal.

### CROSS REFERENCE AND PRIORITY CLAIM

This patent application is a U.S. National Phase of International Patent Application No. PCT/EP2020/075281 filed Sep. 10, 2020 which claims priority to European Patent Application No. 19197161.3, the disclosure of which being incorporated herein by reference in their entireties.

### FIELD

Disclosed embodiments relates to a method for operating a boarding system for a vehicle, to a corresponding control device and to a boarding system for a vehicle, in particular for a rail vehicle.

Plausibility check of signals enable additional information to be used to control systems. For maintenance purposes, it is possible to use specific algorithms in order to output estimations or predictions, for example.

### SUMMARY

Against this background, disclosed embodiments provide an improved method for operating a boarding system for a vehicle, an improved control device for operating a boarding system for a vehicle and an improved boarding system for a vehicle.

This is achieved by a method for operating a boarding system for a vehicle, by a corresponding control device and by corresponding computer software and also by a boarding system for a vehicle.

### BRIEF DESCRIPTION OF THE FIGURES

Exemplary embodiments of the approach presented here are explained in more detail in the following description with reference to the figures, in which:

FIG. 1 shows a schematic illustration of a vehicle having a boarding system according to one exemplary embodiment;

FIG. 2 shows a schematic graph of characteristic curves according to one exemplary embodiment; and

FIG. 3 shows a flowchart of an operating method according to one exemplary embodiment.

### DETAILED DESCRIPTION

According to embodiments, a boarding inclination can be taken into account, in particular with regard to operation of a boarding system of a vehicle, in particular a rail vehicle. A sensor which makes it possible to draw conclusions with respect to a boarding inclination, for example a gyro sensor, can be installed or used for each door control device, for example. It is therefore possible to determine, in particular, both acceleration and position for each boarding system. The information obtained in this manner can be used inside control algorithms, on the one hand, and can additionally or alternatively also be used, on the other hand, as an input variable for algorithms for condition-based maintenance and additionally or alternatively predictive maintenance. In particular, a device, for example implemented in the form of software, of a door control system can evaluate inclination information provided by such a sensor and can make it available for further processing. For example, inclination information can be obtained or determined for each boarding operation over an entire vehicle length, for example over an entire length of a train. In particular, an inclination measurement can be used to check the plausibility of existing knowledge of the boarding system, more precisely to check the plausibility of signals already present in the door control system by collected information from an inclination sensor, for example a gyro sensor, for each boarding system, for the purpose of adapting control logic adapted to a respective environment or a respective inclination.

According to embodiments, a prediction of a condition of a system or of a component in the sense of condition-based and additionally or alternatively predictive maintenance can therefore be advantageously improved, in particular. There inclination of the boarding system may have a considerable influence on a motor current required for an opening process and additionally or alternatively a closing process of a door. Current data recorded with additional inclination information can therefore reliably allow conclusions to be drawn on whether or not there is possibly a fault in the system. A successful opening process and additionally or alternatively a closing process of the door can therefore be carried out even in the case of an increased current consumption caused by a great inclination. For example, it is also advantageously possible to effect an inclination of all boarding systems over the entire vehicle length, in particular train length, in order to therefore check the plausibility of recorded information, in particular the motor current. This makes it possible to improve the false positive rate of algorithms for condition-based maintenance and additionally or alternatively predictive maintenance. In addition, existing control algorithms can be adapted such that they accordingly allow a higher current consumption of a door drive for certain inclination profiles.

A method for operating a boarding system for a vehicle has the following operations of reading in an inclination signal representing an inclination of the boarding system relative to a reference;

reading in at least one process signal representing a movement process of at least one boarding element of the boarding system; and determining an operating signal for operating the boarding system using the inclination signal and the at least one process signal.

This method or the operations of the method can be implemented, for example, in software or hardware or in a mixed form of software and hardware, for example in an apparatus or a control device.

The vehicle may be a vehicle for transporting passengers, for example a rail vehicle. The vehicle may have a plurality of boarding systems. The boarding system may also be referred to as a door system. The at least one boarding element may be a door, a door leaf, a door wing or the like. The at least one boarding element may also be a sliding operation or the like.

The inclination signal may be read in from an interface to a provision device inside or outside the vehicle. The provision device may be in the form of a measuring device and may have, for example, a gyro sensor, an inclination sensor and additionally or alternatively another sensor element. The provision device may be part of the boarding system. More precisely, the provision device may be arranged on the at least one boarding element, adjacent to the latter, or on a chassis of the vehicle. Alternatively, the provision device may be designed to ascertain the inclination signal from another signal available in the vehicle, for example from a sensor on the carriage or in another system. The provision device may carry out signal processing, for example, and may provide inclination information determined in the process in the form of the inclination signal. According to one embodiment, the provision device is designed to gather corresponding inclination information from a digital map.

The reference to which the inclination refers may be a world coordinate system, a perpendicular or vertical, a reference plane at rail level or the like.

The process signal may be read in from an interface to a measuring device. The process signal may represent data captured the measuring device during the movement process. The measuring device may be part of the boarding system or of the vehicle. The measuring device may comprise at least one sensor which is coupled to at least one element of the boarding system, in particular to at least one drive element. For example, the measuring device may be designed to capture a current flow through at least one drive element for the purpose of carrying out the movement process. The process signal may therefore represent a sequence of measured values captured using the measuring device during the movement process. The process signal may be read in in the form of an electrical input signal via an interface, for example to the measuring device. The measuring device may be designed to capture or measure data regarding the movement process of the at least one boarding element, for example a current consumption of at least one drive element for driving the at least one boarding element of the boarding system. In particular, a process signal may therefore represent a current consumption of at least one drive element for driving the at least one boarding element of the boarding system.

The movement process of the at least one boarding element may be an opening process, a closing process or a door cycle including an opening process and a closing process.

The operating signal may be used, for example, to control or optimize the movement process. For example, the operating signal may be used as a control signal for controlling the drive element or may be included in the generation of such a control signal. Additionally or alternatively, the operating signal can be used to detect a fault in the boarding system affecting the movement process. The operating signal can therefore be additionally or alternatively used as a fault signal or can be included in the generation of such a fault signal.

The inclination signal advantageously makes it possible to evaluate or further process the process signal taking into account the present inclination of the boarding system. This is advantageous since a characteristic of the process signal is influenced by the inclination. Taking the inclination into account makes it possible to distinguish, for example, between a deviation of the characteristic of the process signal from a reference characteristic, which is caused by the inclination, and a deviation of the characteristic of the process signal from a reference characteristic, which is caused by damage. A deviation caused by damage can be taken into account when determining the operating signal.

According to one embodiment, in the determination operation, the inclination signal can be used to check the plausibility of the at least one process signal. In this case, a threshold value comparison, a lookup table or the like can be used in the determination operation to check the plausibility of the at least one process signal on the basis of the inclination signal. Such an embodiment provides the advantage that the boarding system can be operated safely. In this case, control of a drive element, maintenance planning and additionally or alternatively other operating functions can be performed reliably, for example.

The at least one process signal read in in the reading-in operation may represent a characteristic curve of a present behavior of at least one drive element of the boarding system during the movement process.

Therefore, in the determination operation, the operating signal can be determined on the basis of a deviation between the characteristic curve and a reference characteristic curve and additionally or alternatively between the characteristic curve and an inclination-specific reference characteristic curve. In this case, the characteristic curve and the respective reference characteristic curve can be compared using a suitable method, for example in the time domain and/or in the frequency domain. For example, the deviation may represent a difference between the characteristic curve and the respective reference characteristic curve which satisfies a predetermined criterion. Such an embodiment provides the advantage that it is possible to reliably and exactly assess what type of operating state is present, for example whether there is a normal or abnormal operating state.

In this case, the reference characteristic curve may represent a desired behavior of at least one drive element of the boarding system during the movement process. The inclination-specific reference characteristic curve may represent a desired behavior, specific to the present inclination of the boarding system, of at least one drive element of the boarding system during the movement process. The reference characteristic curve and inclination-specific reference characteristic curve may be predetermined and may be read in, for example, via an interface to a memory device. Each characteristic curve may represent, for example, a current consumption of the at least one drive element over the course of the movement process based on positions of the at least one boarding element during the movement process. Such an embodiment provides the advantage that significant information relating to a sequence of the movement process is used to be improved further with regard to its significance using the inclination signal.

In addition, the method may have a operation of outputting the operating signal. In the output operation, the operating signal may be output to an interface to at least one drive element of the boarding system. In this case, the at least one drive element can be controlled using the operating signal. The drive element may be a motor, for example an electric motor. For example, a maximum motor current can be set for the at least one drive element using the operating signal.

Additionally or alternatively, the operating signal and/or the process signal may be output to an interface, and optionally further transmission devices, to a device for executing a maintenance algorithm for generating maintenance information relating to the boarding system. In this case, the maintenance algorithm can be parameterized using the operating signal and/or the process signal. The maintenance algorithm may enable condition-based maintenance and additionally or alternatively predictive maintenance. The maintenance information may have a quantitative and additionally or alternatively qualitative statement with regard to maintenance to be carried out. Such an embodiment provides the advantage that, when controlling the at least one drive element and additionally or alternatively components of the boarding system which are movable for maintenance, the inclination can be taken into account in order to minimize or reliably and correctly detect faults and failures of the boarding system.

The method may comprise a operation of making the inclination signal available to an interface to the device for executing a maintenance algorithm. In this manner, the inclination information can be taken into account by the maintenance algorithm.

The method may comprise a operation of ascertaining the inclination signal from at least one further signal. The inclination signal may generally also be made available to the device for executing a maintenance algorithm. Therefore, the inclination information may not only be taken into account by the control system but may also be made available to the maintenance algorithm. For example, the inclination signal may be calculated from other signals and may be made available for control or evaluation. For example, the inclination signal may be ascertained using a position signal (for example GPS) and a database containing information relating to the platform inclination along the platforms.

The approach presented here also provides a control device which is designed to carry out, control or implement the operations of a variant of a method presented here in corresponding devices. The object on which the approach is based can also be quickly and efficiently achieved by this embodiment variant of the approach in the form of a control device. The provision device may be integrated in the control device or may be arranged outside the control device and possibly also the vehicle. According to one embodiment, the control device has the provision device in the form of an inclination sensor.

To this end, the control device may have at least one computing unit for processing signals or data, at least one memory unit for storing signals or data, at least one interface to a sensor or an actuator for reading in sensor signals from the sensor or for outputting data or control signals to the actuator and/or at least one communication interface for reading in or outputting data embedded in a communication protocol. The computing unit may be, for example, a signal processor, a microcontroller or the like, wherein the memory unit may be a flash memory, an EPROM or a magnetic memory unit. The communication interface may be designed to read in or output data in a wireless and/or wired manner, wherein a communication interface which can read in or output wired data can read in these data from a corresponding data transmission line or can output said data to a corresponding data transmission line, for example electrically or optically.

In the present case, a control device may be understood as meaning an electrical device which processes sensor signals and outputs control and/or data signals on the basis thereof. The control device may have an interface which may be in the form of hardware and/or software. When in the form of hardware, the interfaces may be, for example, part of a so-called system ASIC which comprises a wide variety of functions of the control device. However, it is also possible for the interfaces to be separate, integrated circuits or to be at least partially composed of discrete components. When in the form of software, the interfaces may be software modules which are present on a microcontroller in addition to other software modules, for example.

A boarding system for a vehicle may have an embodiment of the control device mentioned above; and the at least one boarding element and at least one drive element for effecting the movement process of the boarding element, wherein the control device and the at least one drive element are connected to one another so as to be capable of transmitting signals.

An embodiment of the control device mentioned above can be advantageously utilized or used in the boarding system to operate the boarding system or control operation of the boarding system. The boarding system may also have at least one capture device for capturing data on which the process signal is based. The control device may be connected to the at least one capture device so as to be capable of transmitting signals. The boarding system may also have a device for executing a maintenance algorithm, in particular an algorithm for condition-based maintenance and additionally or alternatively an algorithm for predictive maintenance. The execution device may be connected to the control device so as to be capable of transmitting signals or may be combined with the control device.

According to one embodiment, the boarding system may have the provision device. The provision device may be designed to capture or determine the inclination of the boarding system relative to the reference and to provide the inclination signal representing the inclination. In this case, the control device and the provision device may be connected to one another so as to be capable of transmitting signals. Such an embodiment provides the advantage that inclination information can be taken into account for operation for each boarding system of the vehicle.

Also advantageous is a computer program product or computer program having program code which can be stored on a machine-readable carrier or storage medium such as a semiconductor memory, a hard disk memory or an optical memory and is used to carry out, implement and/or control the operations of the method according to one of the embodiments described above, in particular when the program product or program is executed on a computer, a control device or an apparatus.

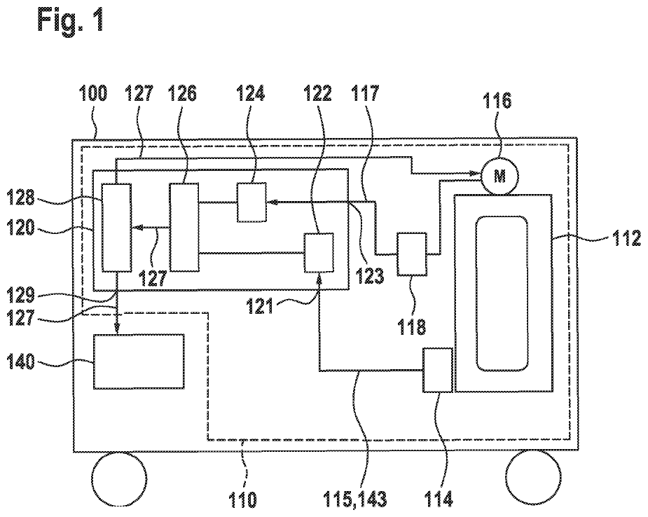

FIG. 1 shows a schematic illustration of a vehicle 100 having a boarding system 110 according to one exemplary embodiment. The vehicle 100 is a rail vehicle, for example. The vehicle 100 has the boarding system 110. Even though not explicitly shown in FIG. 1, the vehicle 100 may have a plurality of boarding systems 110.

The boarding system 110 of the vehicle 100 has at least one boarding element 112, here in the form of a door or a door leaf, at least one drive element 116 and a control device 120 for operating the boarding system 110. The boarding element 112 is arranged so as to be movable relative to a chassis of the vehicle 100. A movement process of the boarding element 112 comprises an opening process and/or a closing process. The at least one drive element 116 is designed to effect the movement process of the at least one boarding element 112. The drive element 116, which is shown in FIG. 1, is an electric motor or the like, for example. The control device 120 and the at least one drive element 116 are connected to one another so as to be capable of transmitting signals.

According to the exemplary embodiment illustrated here, the door system 110 also comprises a provision device 114. The provision device 114 is designed to capture or determine an inclination of the boarding system 110 relative to a reference. The reference is, for example, a vertical, a perpendicular or a reference plane which is based on an environment of the vehicle 100, for example on rails on which the vehicle 100 moves. The provision device 114 is also designed to provide an inclination signal 115 representing the captured inclination. According to the exemplary embodiment illustrated here, the provision device 114 is arranged adjacent to the boarding element 112. According to another exemplary embodiment, the provision device 114 may be arranged on the boarding element 112. The control device 120 and the provision device 114 are connected to one another so as to be capable of transmitting signals.

According to an alternative exemplary embodiment, the provision device 114 is fastened to the vehicle 100 at a distance from the boarding system 110 and the boarding system 110 has an interface for reading in the inclination signal 115. In this case, a captured inclination of the vehicle 100 may be used as being representative of the inclination of the boarding system 110.

According to the exemplary embodiment illustrated here, the door system 110 also comprises a measuring device 118. According to another exemplary embodiment, the measuring device 118 may also be provided separately from the door system 110 or may be integrated in a control system, for example in the control device 120. The drive element 116 is connected to the measuring device 118 so as to be capable of transmitting signals. The measuring device 118 is connected to the apparatus 120 so as to be capable of transmitting signals. Therefore, there is a connection capable of transmitting signals between the drive element 116 and the apparatus 120. In this case, the measuring device 118 is shown as being connected between the drive element 116 and the control device 120 merely by way of example. The measuring device 118 is designed to provide at least one process signal 117 representing a movement process of the at least one boarding element 112 of the boarding system 110. According to the exemplary embodiment illustrated here, the measuring device 118 is designed to measure a motor current or a current consumption of the drive element 116 and to provide measured values in the form of the at least one process signal 117. The process signal 117 therefore represents, for example, a temporal profile of the current consumption of the drive element 116 during the movement process.

The control device 120 has a first reading-in device 122, a second reading-in device 124 and a determination device 126. The first reading-in device 122 is designed to read in the inclination signal 115 from the provision device 114 or from an interface 121 to the provision device 114. The inclination signal 115 represents the inclination of the boarding system 110 relative to the reference. The first reading-in device 122 is designed to forward the inclination signal 115 to the determination device 126. The second reading-in device 124 is designed to read in the process signal 117. In this case, the second reading-in device 124 is designed to read in the process signal 117 from the drive element 116 or the measuring device 118, more precisely from a further interface 123 to the drive element 116 or the measuring device 118. According to one exemplary embodiment, the measuring device 118 is included in the control device 120. According to one exemplary embodiment, a measurement which produces the process signal 117 is carried out as part of the control logic implemented by the control device 120. The process signal 117 represents the movement process of the at least one boarding element 112 of the boarding system 110. The second reading-in device 124 is designed to forward the process signal 117 to the determination device 126. The determination device 126 is designed to determine an operating signal 127 for operating the boarding system 110 using the inclination signal 115 and the at least one process signal 117. According to one exemplary embodiment, the determination device 126 is designed to check the plausibility of the at least one process signal 117 using the inclination signal 115. According to one exemplary embodiment, a result of the plausibility check is included in the determination of the operating signal 127.

According to the exemplary embodiment illustrated here, the control device 120 also has an output device 128. The output device 128 is designed to output the operating signal 127 determined by the determination device 126. In this case, the output device 128 is designed to output the operating signal 127 to an interface or output interface 129 to the at least one drive element 116 of the boarding system. In this case, the at least one drive element 116 can be controlled using the operating signal 127. In other words, the operating signal 127 can be used to control the at least one drive element 116. Additionally or alternatively, the output device 128 is designed to output the operating signal 127 to the output interface 129 to a device 140 for executing a maintenance algorithm for generating maintenance information relating to the boarding system 110. In this case, the maintenance algorithm can be parameterized using the operating signal 127. In other words, the operating signal 127 can be used to parameterize the maintenance algorithm. The maintenance algorithm is an algorithm for condition-based maintenance and/or an algorithm for predictive maintenance.

According to an alternative exemplary embodiment, the determination device 126 is located outside the control device 120, for example in a computing center for optimizing maintenance. The determination device 126 may also be arranged away from the vehicle 100. In this case, the device 140 may likewise be implemented in the external computing center. In this respect, the inclination signal 115 and the process signal 117 are then transmitted from the control device 120 to the device 140 either without change or in a preprocessed form, for example in the form of the operating signal 127, via the interface 129 and possibly further transmission elements.

According to a different exemplary embodiment, the provision device 114 is in the form of a measuring device for capturing the inclination or in the form of an ascertainment device for ascertaining the inclination from signals or information which is/are already available. The provision device 114 may be arranged both inside and outside the vehicle 100.

According to one exemplary embodiment, the at least one process signal 117 represents a characteristic curve of a present behavior of the at least one drive element 116 during the movement process. The profile of the characteristic curve depends on the inclination of the boarding system 110. According to one exemplary embodiment, the process signal 117 is compared with a reference characteristic curve which represents a desired behavior of the at least one drive element 116 during the movement process. The comparison makes it possible to ascertain a deviation between the present characteristic curve represented by the process signal 117 and the reference characteristic curve. Such a deviation may be caused by a fault or damage to the boarding system 110. Since the inclination of the boarding system 110 influences the process signal 117, the deviation may also be caused by the inclination, however. Therefore, according to one exemplary embodiment, the process signal 117 is compared with an inclination-specific reference characteristic curve which represents a desired behavior, specific to the present inclination of the boarding system 110, of the at least one drive element 116 during the movement process. If a comparison between the present characteristic curve represented by the process signal 117 and the inclination-specific reference characteristic curve reveals a deviation, this indicates a fault or damage to the boarding system 110. According to one exemplary embodiment, the inclination-specific reference characteristic curve is selected from a plurality of inclination-specific reference characteristic curves, predetermined for different inclinations, using the inclination signal 115. The plurality of inclination-specific reference characteristic curves predetermined for different inclinations are stored, for example, in a memory device of the boarding system 110. According to one exemplary embodiment, the determination device 126 is designed to read the inclination-specific reference characteristic curve assigned to the present inclination of the boarding system 110 from the memory device using the inclination signal 115 and to use it to determine the operating signal 127. For example, the determination device 126 is designed to determine the operating signal 127 on the basis of a deviation between the characteristic curve and the reference characteristic curve and/or between the characteristic curve and the inclination-specific reference characteristic curve. Depending on a magnitude of the deviation, a maximum of the operating signal 127, for example, may be limited, that is to say, for example, a maximum current flow through the drive element 116 may be limited, or a fault message may be generated and output using the operating signal 127.

According to one exemplary embodiment, the first reading-in device 122 is optionally designed to read in an acceleration signal 143 from the interface 121 to the provision device 114. In this case, the acceleration signal 143 represents an acceleration of at least one boarding element 112 during the movement process. In particular, the provision device 114 is in the form of a gyro sensor in this case and is designed to capture the acceleration. In this case, the determination device 126 is designed to determine the operating signal 127 using the acceleration signal 143. The acceleration signal 143 may be used in addition or as an alternative to the inclination signal 115. For example, an inclination may be determined from the acceleration signal 143. The provision device 114 may therefore comprise a sensor for capturing the inclination and the acceleration or separately designed and optionally separately arranged sensors for capturing the inclination and the acceleration.

According to one exemplary embodiment, a gyro sensor is installed as a provision device 114 for each door control device or boarding system 110. The control device 120 evaluates the information provided by the provision device 114 with regard to the boarding inclination in the form of the inclination signal 115. Recording and processing of the collected information and provision with further signals from the control device 120 as input variables for maintenance algorithms are also carried out. Additionally or alternatively, the maximum permissible motor current through the control device 120 is adapted on the basis of the information from the provision device 114.

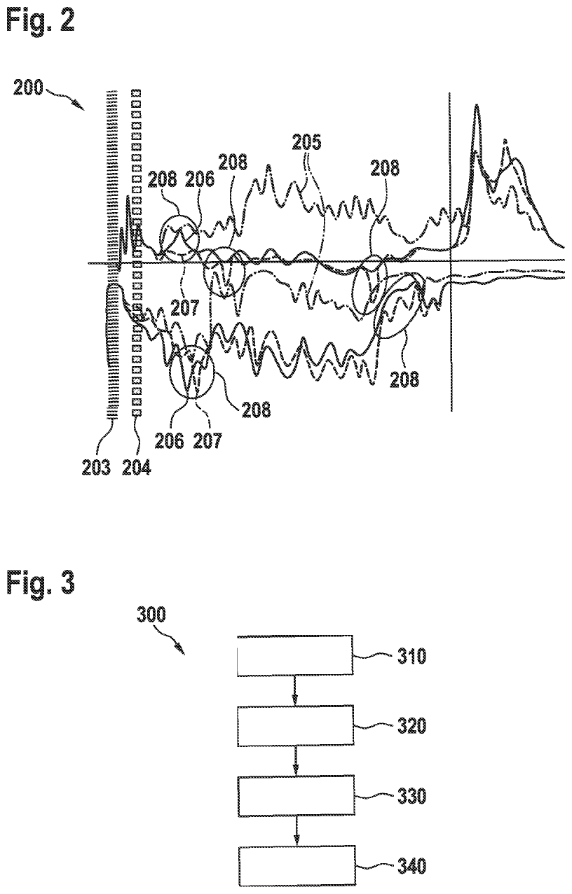

FIG. 2 shows a schematic graph 200 of characteristic curves 205, 206 and 207 assigned to a movement process of at least one boarding element of the boarding system according to one exemplary embodiment. According to this exemplary embodiment, the movement process comprises both an opening process and a closing process. The characteristic curves 205, 206 and 207 are represented by the at least one process signal from FIG. 1 or a similar process signal. In other words, the control device from FIG. 1 or a similar control device is designed to use the characteristic curves 205, 206 and 207 to determine an operating signal for operating a boarding system. A position profile of positions of the boarding element of the boarding system, for example in pulses of a sensor signal from a position sensor or travel sensor, is plotted on an abscissa axis of the graph 200. A current or current profile or a current consumption of the at least one drive element of the boarding system from FIG. 1 or of a similar boarding system is plotted on an ordinate axis of the graph 200, for example in milliamperes.

A locked state 203 and an unlocked state 204 of the boarding system are illustrated parallel to the ordinate axis as a division of the abscissa axis. The reference characteristic curve 205, which is described with reference to FIG. 1, is depicted in the graph 200. The reference characteristic curve 205 represents an initial state or normal state of the boarding system. The inclination-specific reference characteristic curve 206, which is described with reference to FIG. 1, is likewise depicted in the graph 200. The inclination-specific reference characteristic curve 206 represents, merely by way of example, an inclination of the boarding system to the outside of 8°. The characteristic curve 207, which is described with reference to FIG. 1, is likewise depicted in the graph 200. The characteristic curve 207 represents, merely by way of example, an inclination of the boarding system to the outside of 8°, wherein a bearing has popped out. Furthermore, deviations 208 are also depicted in the graph 200. There are significant differences between measurement data of the at least one process signal in the region of the deviations 208. In this case, the deviations 208 exist between the inclination-specific reference characteristic curve 206 and the characteristic curve 207. For example, the deviations 208 are caused by differences before and after a defect of a pivot bearing of a right-hand rotary column of the boarding system. According to one exemplary embodiment, the deviations 208 are taken into account when determining the operating signal, for example using a predetermined determination rule. In this manner, the operating signal can be adapted to the deviations 208, for example to a number and/or magnitude of the deviations 208.

FIG. 3 shows a flowchart of an operating method 300 according to one exemplary embodiment. The method 300 can be carried out in order to operate a boarding system for a vehicle, in particular the boarding system from FIG. 1 or a similar boarding system. In this case, the operating method 300 can be carried out by using the control device from FIG. 1 or a similar control device.

In a first reading-in operation 310, an inclination signal is read in from an interface to a provision device. The inclination is optionally measured or ascertained using the provision device and is provided in the form of the inclination signal. In order to ascertain the inclination, a position of the boarding system can be ascertained, for example, and an inclination stored for the position can be read from a database. The inclination signal represents an inclination of the boarding system relative to a reference. In a second reading-in operation 320, at least one process signal representing a movement process of at least one boarding element of the boarding system is read in. The first reading-in operation 310 and the second reading-in operation 320 can be carried out with a time delay or at the same time. An operating signal for operating the boarding system is then determined in a determination operation 330 using the inclination signal and the at least one process signal.

According to one exemplary embodiment, the operating method 300 also has a operation 340 of outputting the operating signal. In the output operation 340, the operating signal is output to an interface to at least one drive element of the boarding system. In this case, the at least one drive element can be controlled using the operating signal. Additionally or alternatively, in the output operation 340, the operating signal and/or the inclination signal and/or the process signal is/are output to a device for executing a maintenance algorithm for generating maintenance information relating to the boarding system. In this case, the maintenance algorithm can be parameterized using the operating signal.

Operations 310, 320, 330, 340 can be carried out using devices inside and/or outside the vehicle.

### LIST OF REFERENCE SIGNS

100 Vehicle
110 Boarding system
112 Boarding element
114 Provision device
115 Inclination signal
116 Drive element
117 Process signal
118 Measuring device
120 Control device
121 Interface
122 First reading-in device
123 Further interface
124 Second reading-in device
126 Determination device
127 Operating signal
128 Output device
129 Output interface
140 Executing device
143 Acceleration signal
200 Graph
203 Locked state
204 Unlocked state
205 Reference characteristic curve
206 Inclination-specific reference characteristic curve
207 Characteristic curve
208 Deviation
300 Operating method
310 Reading-in operation
320 Reading-in operation
330 Determination operation
340 Output operation

1. A method for operating a boarding system for a vehicle, wherein the method comprises:
reading in an inclination signal representing an inclination of the boarding system relative to a reference;
reading in at least one process signal representing a movement process of at least one boarding element of the boarding system; and
determining an operating signal for operating the boarding system using the inclination signal and the at least one process signal.

2. The method of claim 1, in which the inclination signal is read in from an interface to a provision device inside or outside the vehicle.

3. The method of claim 1, in which, in the determination, the inclination signal is used to check the plausibility of the at least one process signal.

4. The method of claim 1, wherein the at least one process signal read in in the reading-in operation represents a characteristic curve of a present behavior of at least one drive element of the boarding system during the movement process.

5. The method of claim 4, in which, in the determination, the operating signal is determined on the basis of a deviation between the characteristic curve and a reference characteristic curve and/or between the characteristic curve and an inclination-specific reference characteristic curve, wherein the reference characteristic curve represents a desired behavior of at least one drive element of the boarding system during the movement process, and the inclination-specific reference characteristic curve represents a desired behavior, specific to the present inclination of the boarding system, of at least one drive element of the boarding system during the movement process.

6. The method of claim 1, in which, in the reading-in operation, an acceleration signal is read in from the interface to the provision device, wherein the acceleration signal represents an acceleration of at least one boarding element of the boarding system during the movement process, wherein, in the determination operation, the operating signal is determined using the acceleration signal.

7. The method of claim 1, further comprising outputting the operating signal to an interface to at least one drive element of the boarding system, wherein the at least one drive element is controlled using the operating signal.

8. The method of claim 1, further comprising outputting the operating signal and/or the process signal to an interface, and optionally further transmission devices, to a device for executing a maintenance algorithm for generating maintenance information relating to the boarding system, wherein the maintenance algorithm is parameterized using the operating signal and/or the process signal.

9. The method of claim 8, further comprising making the inclination signal available to an interface to the device for executing a maintenance algorithm.

10. The method of claim 8, further comprising ascertaining the inclination signal from at least one further signal, wherein the inclination signal is also made available to the device for executing a maintenance algorithm.

11. A control device configured to carry out and/or control operating a boarding system for a vehicle, wherein the operation:
reading in an inclination signal representing an inclination of the boarding system relative to a reference;
reading in at least one process signal representing a movement process of at least one boarding element of the boarding system; and
determining an operating signal for operating the boarding system using the inclination signal and the at least one process signal.

12. The control device which has an integrated provision device that is an inclination sensor.

13. A boarding system for a vehicle, wherein the boarding system comprises:
the control device of claim 11; and
at least one boarding element and at least one drive element for effecting the movement process of the boarding element, wherein the control device and the at least one drive element are connected to one another so as to be capable of transmitting signals.

14. The boarding system of claim 13, having the provision device, wherein the provision device is designed to capture the inclination of the boarding system relative to the reference and to provide the inclination signal, wherein the control device and the provision device are connected to one another so as to be capable of transmitting signals, or wherein the provision device is included in the control device.

15. A non-transitory computer readable medium including a computer program which is configured to carry out and/or control a method.

16. The control device of claim 11, wherein the inclination signal is read in from an interface to a provision device inside or outside the vehicle.

17. The control device of claim 11, wherein, in the determination, the inclination signal is used to check the plausibility of the at least one process signal.

18. The control device of claim 11, wherein the at least one process signal read in in the reading-in operation represents a characteristic curve of a present behavior of at least one drive element of the boarding system during the movement process.

19. The control device of claim 11, in which, in the determination, the operating signal is determined on the basis of a deviation between the characteristic curve and a reference characteristic curve and/or between the characteristic curve and an inclination-specific reference characteristic curve, wherein the reference characteristic curve represents a desired behavior of at least one drive element of the boarding system during the movement process, and the inclination-specific reference characteristic curve represents a desired behavior, specific to the present inclination of the boarding system, of at least one drive element of the boarding system during the movement process.

20. The control device of claim 11, in which, in the reading-in operation, an acceleration signal is read in from the interface to the provision device, wherein the acceleration signal represents an acceleration of at least one boarding element of the boarding system during the movement process, wherein, in the determination operation, the operating signal is determined using the acceleration signal.
